(19) United States
(12) Patent Application Publication
(10) Pub. No.: US 2017/0191619 A1
(43) Pub. Date: Jul. 6, 2017

(54) SYSTEM AND METHOD FOR STORING AND TRANSFERRING A CRYOGENIC LIQUID

(71) Applicant: Green Buffalo Fuel, LLC, Tonawanda, NY (US)

(72) Inventors: Kenneth Leo SNYDER, Hamburg, NY (US); James Joseph DONOVAN, Tonawanda, NY (US); Robert Francis DESJARDINS, Boston, NY (US); Brendan Morton NEILL, Buffalo, NY (US)

(21) Appl. No.: 14/985,870

(22) Filed: Dec. 31, 2015

(51) Int. Cl. F17C 5/04; F17C 13/00

(52) U.S. Cl. CPC F17C 5/04; F17C 13/001; F17C 2203/03; F17C 2205/0138; F17C 2221/033; F17C 2260/035; F17C 2270/01; F17C 2205/0352

(57) ABSTRACT

This fluid storage and transfer system includes a first storage tank and second storage tank configured to contain cryogenic liquids. The first storage tank has a heat exchanger. A second cryogenic liquid from the second storage tank subcools a first cryogenic liquid in the first storage tank and pressurizes the first storage tank. The first storage tank is then further pressurized using the heat exchanger. The first cryogenic fluid is transferred from the first storage tank to an end point. In an example, the first cryogenic fluid is liquefied natural gas and the second cryogenic fluid is liquid nitrogen.

### FIELD OF THE DISCLOSURE

This disclosure relates to storage and transfer of liquids and, more particularly, to storage and transfer of cryogenic liquids.

### BACKGROUND OF THE DISCLOSURE

Liquefied natural gas (LNG) is natural gas converted to a liquid form for storage or transport. LNG is odorless, colorless, non-toxic, and non-corrosive. The predominant component of LNG is methane (CH₄), but LNG also can include ethane (C₂H₆), propane (C₃H₈), butane (C₄H₁₀), other hydrocarbons, or other gases. Natural gas, including LNG, is generally considered one of the most environmentally friendly fossil fuels because it has the lowest CO₂ emissions per unit of energy. The volumetric energy density of LNG is greater than that of compressed natural gas (CNG), making it a more feasible fuel choice. Thus, LNG is gaining acceptance as a mainstream vehicle fuel. For example, use of LNG as fuel in the trucking industry is growing in popularity.

To transfer LNG from a storage tank to a receiving tank, the pressure of the incoming LNG must be greater than that of the receiving tank. To achieve this pressure differential, the pressure in the receiving tank can be reduced, such as by venting the receiving tank to a pressure lower than the pressure in the storage tank, or the pressure of the incoming LNG can be increased. Venting LNG out of the system is undesirable because fuel that can be re-liquefied and used is lost. Furthermore, venting LNG from the receiving tank into the storage tank equalizes the pressure between the two tanks, which is not conducive to fueling as a pressure differential is generally needed. In addition, venting LNG can cause quality issues for the remaining LNG because hydrocarbons that make up LNG boil at different temperatures. In LNG, methane has a lower boiling point than ethane, which will result methane boiling off and being vented first, thus increasing the concentration of ethane in the remaining LNG. As each hydrocarbon in LNG has a different energy density, performance issues may result when the hydrocarbon concentration of the liquid changes. Furthermore, venting the LNG to atmosphere emits powerful greenhouse gases, like methane. Thus, it may be desirable to avoid venting LNG.

To transfer LNG from a storage tank to a receiving tank without venting, pumps can be used to create a positive pressure differential between the LNG to be delivered and the receiving tank or other end use application. These pumps can be either internal to the storage tank or external. External pumps will need to go through an initial cool down stage where LNG is circulated through the pump and related piping. During the cool down stage, the LNG will vaporize as it comes into contact with the warmer piping and/or pump and can be sent back into the storage tank, which will increase the temperature and pressure within the storage tank, or can be vented. In addition, the cool down phase is not immediate and will add time to the fueling process.

Internal pumps can be configured to be cooled to the temperature of the LNG within the storage tank and, therefore, always be ready to pump. However, the location of an internal pump inside the storage tank makes servicing such a pump difficult, as the storage tank must be emptied and purged of LNG before the pump can be serviced. In addition, an internal pump will introduce heat into the storage tank when activated. This can affect the properties of the LNG and may require additional compensation.

To avoid or rely less on a pump, the pressure in the storage tank can be increased by using a heat exchanger to vaporize a portion of the LNG and return it to the ullage space of the storage tank, thereby increasing the pressure in the storage tank. However, a portion of the vapor space will need to be vented to return to the original saturated temperature and pressure. If vapor is not vented and the storage tank remains at high pressure, the LNG will be saturated, which will increase vaporization when transferred to a receiving tank. In addition, building pressure in a storage tank by using a heat exchanger is slow, which will hamper the adoption of LNG vehicle fueling.

Liquid nitrogen (LIN) can be added to the LNG storage tank to build pressure. LIN has a lower boiling point than LNG. Colder LIN will subcool the LNG and boil into the storage tank ullage space where it will increase the pressure in the storage tank. Once a transfer is completed, the nitrogen in the ullage space can be vented to reduce the pressure of the storage tank without venting natural gas. However, this requires a substantial quantity of LIN, which increases the cost of fueling. Increasing the pressure in the storage tank is delayed while the LNG heats up through convection, conducting, or radiation or while adding more nitrogen. This makes it difficult to build pressure when a supply of nitrogen is not readily available. Furthermore, this process is slow and may not provide sufficient pressure to transfer the LNG.

LIN can be sent through a coil in the ullage space of a storage tank to condense the LNG and reduce the pressure in the ullage space of the tank. However, the LIN only comes in thermal contact with the LNG vapor if the coil is present in the ullage space. Thus, the LIN is not used to build pressure in the storage vessel. While keeping LNG at a low pressure when not in use may be preferred, another technique is needed to increase pressure for transfer.

Therefore, what is needed is an improved fluid storage and transfer system.

### BRIEF SUMMARY OF THE DISCLOSURE

In a first embodiment, a system is provided. The system includes a first storage tank, a second storage tank, a heat exchanger, and a piping system. The first storage tank is insulated and is configured to contain a first cryogenic liquid. The second storage tank is configured to contain a second cryogenic liquid.

The second storage tank is connected to the first storage tank to provide a flow of the second cryogenic liquid that subcools the first cryogenic liquid and pressurizes the first storage tank. The second storage tank may be configured to be removable from the first storage tank. The second storage tank may be connected to a bottom of the first storage tank. The second storage tank may be connected to the first storage tank such that the flow of the second cryogenic liquid is into the first cryogenic liquid

The heat exchanger is connected to the first storage tank and is configured such that the first cryogenic liquid flows into the heat exchanger, vaporizes, and flows into ullage space in the first storage tank. The heat exchanger may be configured to use at least one of gravity or head pressure to enable flow of the first cryogenic liquid through the heat exchanger.

The piping system connects the first storage tank to an end point. The piping system may be connected to a bottom of the first storage tank.

The first cryogenic liquid may include liquefied natural gas and the second cryogenic liquid may include liquid nitrogen.

In a second embodiment, a method is provided. The method includes transferring a second cryogenic liquid from a second storage tank to a first storage tank that is at a first pressure. The first storage tank contains a first cryogenic liquid different from the second cryogenic liquid and the first cryogenic liquid has a boiling point less than or equal to −150° F. under normal atmospheric pressure. The second cryogenic liquid has a boiling point below that of the first cryogenic liquid. The first cryogenic liquid is subcooled in the first storage tank with the second cryogenic liquid. The first storage tank is pressurized with the second cryogenic liquid to a second pressure greater than the first pressure. The first storage tank is pressurized with a heat exchanger to a third pressure greater than the second pressure. The first cryogenic fluid is transferred from the first storage tank when the first storage tank is at the third pressure.

The first cryogenic liquid may include liquefied natural gas and the second cryogenic liquid may include liquid nitrogen.

The first storage tank may be vented after the transferring. The first storage tank may be filled with a cryogenic liquid after the transferring. Pressurization of the first storage tank with the heat exchanger may continue during the transferring of the first cryogenic fluid from the first storage tank.

At least one of gravity or head pressure may be used to enable the first cryogenic liquid to flow through the heat exchanger.

### DESCRIPTION OF THE DRAWINGS

For a fuller understanding of the nature and objects of the disclosure, reference should be made to the following detailed description taken in conjunction with the accompanying drawings, in which:

FIG. 1 is a schematic of a fluid storage and transfer system in accordance with the present disclosure;

FIG. 2 is a flowchart of operation of the fluid storage and transfer system in accordance with the present disclosure;

FIGS. 3-6 are schematics illustrating the operation of the fluid storage and transfer system of FIG. 1; and

FIG. 7 is a chart showing results of a pressurization experiment using an embodiment of the system in FIG. 1.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

The present disclosure can be used to store and transfer a cryogenic liquid, such as LNG. The cryogenic liquid may be transferred from a storage tank to a receiving tank or to an end use application such as a vehicle. A second cryogenic liquid, such as nitrogen or helium, is used to subcool and pressurize a cryogenic liquid in the storage tank. A heat exchanger works in conjunction with the second cryogenic liquid to further pressurize the storage tank. The pressure level of the liquid in the storage tank can be changed to a pressure level sufficient for transfer to a receiving tank or end use application without the use of a pump. Avoiding use of pumps removes a heat source proximate the storage tank.

Cryogenic liquids include liquefied gases or mixtures of liquefied gases that boil at or below −150° F. under normal atmospheric pressure. LNG is one such liquid, as it boils at −258° F. under normal atmospheric pressure. LNG is made up of multiple hydrocarbons, including methane, ethane, propane, butane, and other hydrocarbons in trace amounts. Each hydrocarbon has a unique boiling point and pressure, but all these hydrocarbons are in liquid form at −258° F. For example, at a given pressure methane has a lower boiling point than ethane, ethane has a lower boiling point than propane, and propane has a lower boiling point than larger alkane molecules.

LNG is normally stored as a saturated liquid, approximately at or around its boiling point. If any heat is added to a storage tank containing LNG, the saturated pressure within the storage tank will rise, which, in turn, will decrease both the volumetric density and the energy density of the LNG. Thus, it may be desirable to keep LNG stored as a saturated liquid at low pressure. Because of the low temperatures required to keep the cryogen as a saturated liquid, both storage tanks and receiving tanks may be double-walled, vacuum-insulated vessels with the space between the two vessels containing one or more insulating materials. This is done to improve the thermal performance of the vessel by insulating the stored cryogen from the atmosphere or ambient temperature.

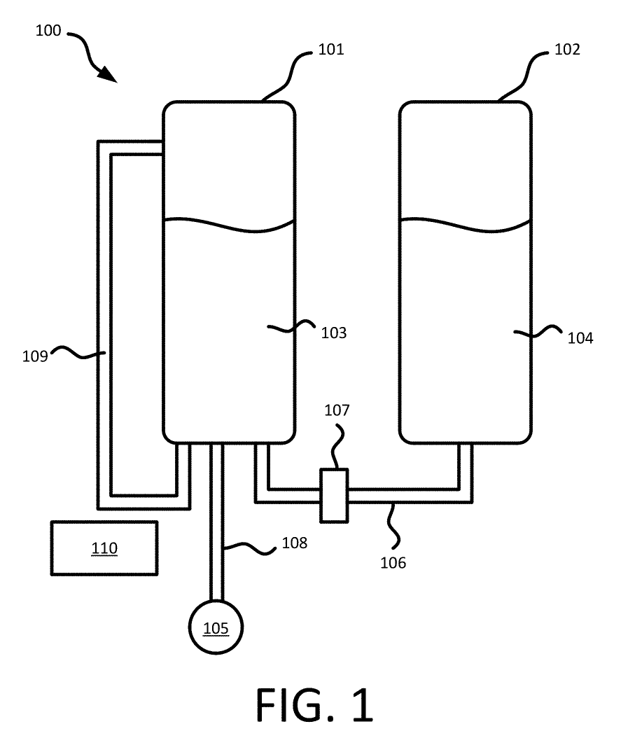

FIG. 1 is a schematic of a fluid storage and transfer system 100. To transfer the first cryogenic liquid 103, such as LNG, from the first storage tank 101 to an end point 105 (e.g., a receiving tank, vehicle, or other end use application), a second cryogenic liquid 104 and a heat exchanger 109 are used. The second cryogenic liquid 104 and heat exchanger 109 can build pressure in the first storage tank 101 to a level sufficient to transfer the first cryogenic liquid 103 to the end point 105.

The heat exchanger 109 may be disposed in the shroud of the first storage tank 101. The heat exchanger 109 can include multiple fins (not illustrated) that help transfer ambient heat to the fluid flowing in the heat exchanger 109. In an instance, an entrance for the heat exchanger 109 is connected to the first storage tank 101 on the bottom surface or elsewhere where the first cryogenic liquid 103 is located in the first storage tank 101. An exit for the heat exchanger 109 may be connected in the ullage space of the first storage tank 101. Gravity or head pressure may cause the first cryogenic liquid 103 to flow through the heat exchanger 109. The heat exchanger 109 may include valves (not illustrated) at the entrance and exit with the first storage tank 101.

The first storage tank 101 can store the first cryogenic liquid 103 as a liquid at an initial pressure and temperature. For example, the first storage tank 101 may store the first cryogenic liquid 103 at approximately 30 psi and at a temperature less than −150° F. The second storage tank 102 contains the second cryogenic liquid 104 at an initial pressure and temperature.

The first storage tank 101 and second storage tank 102 can maintain the first cryogenic liquid 103 and second cryogenic liquid 104 at a desired temperature. Both the first storage tank 101 and second storage tank 102 may be double-walled, vacuum-insulated vessels with the space between the two vessels containing one or more insulating materials. The temperature of the first storage tank 101 may be configured to minimize vaporization of the first cryogenic liquid 103. In an instance, the first cryogenic liquid 103 is stored near its boiling point for a storage pressure. As vapor boils off the first cryogenic liquid 103, any added heat is countered by energy lost from this boil off. The temperature within the first storage tank 101 can remain constant if the pressure is kept constant by allowing the boil off gas to escape from the first storage tank 101, which is referred to as auto-refrigeration. Other refrigeration techniques for the first cryogenic liquid 103 are possible.

The second cryogenic liquid 104 has a boiling point below that of the first cryogenic liquid 103. The second cryogenic liquid 104 may be LIN, though other second cryogenic liquids 104 besides LIN are possible. LIN may be more cost effective than other cryogenic liquids. LIN also is inert. The second cryogenic liquid 104 may be a mixture of two or more cryogenic liquids.

A piping system 106 connects the second storage tank 102 with the second cryogenic liquid 104 to the first storage tank 101. The piping system 106 is configured to provide at least one fluidic path for the second cryogenic liquid 104 to flow in liquid or vapor form from the second storage tank 102 to the first storage tank 101. The piping system 106 may connect to the bottom of the first storage tank 101 or elsewhere on the first storage tank 101 where the first cryogenic liquid 103 is located (e.g., not the ullage space in the first storage tank 101) so that the second cryogenic liquid 104 can flow into the first cryogenic liquid 103.

A piping system 108 connects the first storage tank 101 to the end point 105. The connection between the piping system 108 and the first storage tank 101 may be on the bottom of the first storage tank 101 or elsewhere on the first storage tank 101 where the first cryogenic liquid 103 is located (e.g., not the ullage space in the first storage tank 101). The piping system 108 is configured to provide at least one fluidic path for a liquid or vapor to flow from the first storage tank 101. The piping system 108 can include at least one valve (not illustrated) to selectively enable transfer from the first storage tank 101 and/or one or more check valves (not illustrated) to prevent backflow.

Both the piping system 106 and piping system 108 are configured to allow for sufficient flow and have minimal flow restrictions. For example, the piping systems 106, 108 may include sections with vacuum-jacketed piping. Any valves in the fluid storage and transfer system 100 may be, for example, a cryogenic valve that can be actuated.

The second storage tank 102 may be removable. The piping system 106 includes a detachment point 107 for removal of the second storage tank 102. One or more valves may be disposed at or around the detachment point 107. For example, the piping system 106 may include a valve (not illustrated) on one or both sides of the detachment point 107 to reduce or prevent leakage during connections and disconnections.

The fluid storage and transfer system 100 further includes a controller 110. The controller 110 can, for example, control the operation of valves in the fluid storage and transfer system 100.

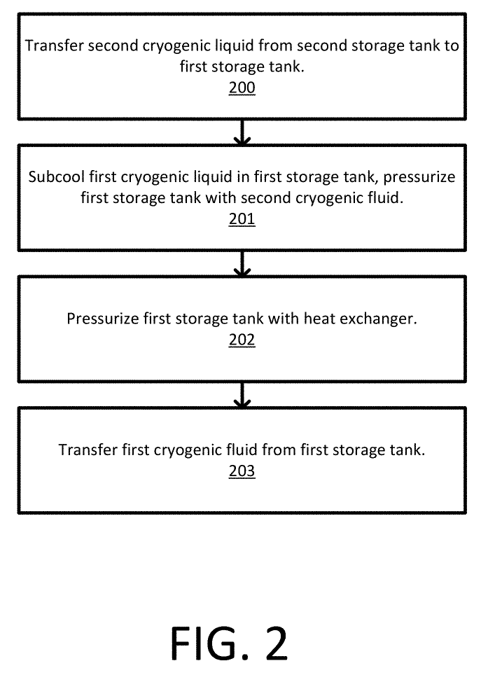

FIG. 2 is a flowchart of operation of the fluid storage and transfer system in accordance with the present disclosure. In 200, the second cryogenic liquid is transferred from the second storage tank to the first storage tank that contains the first cryogenic liquid. In 201, the second cryogenic fluid subcools the first cryogenic fluid and pressurizes the first storage tank. In 202, the first storage tank is pressurized with the heat exchanger. In 203, the first cryogenic fluid is transferred from the first storage tank.

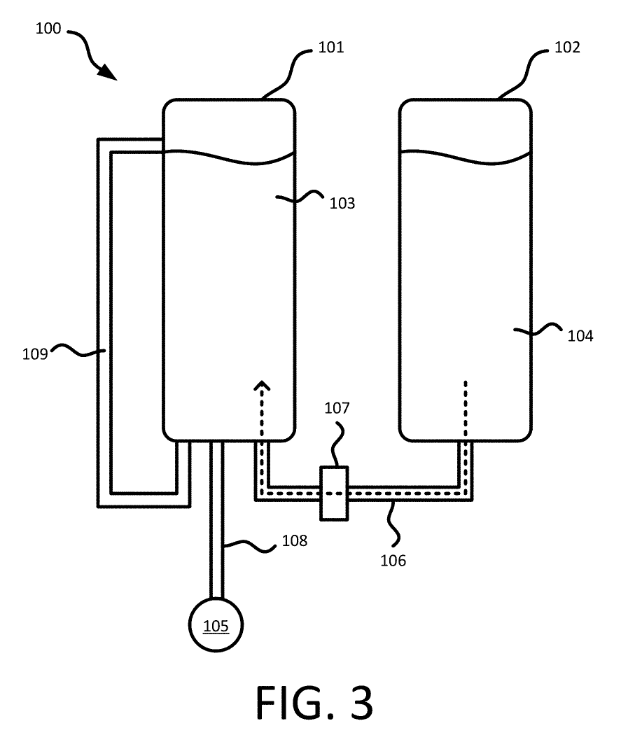

FIGS. 3-6 are schematics illustrating the operation of the fluid storage and transfer system of FIG. 1. During operation, the first cryogenic liquid 103 is held in the first storage tank 101 as an unsaturated liquid at a first pressure (P1). In an example, P1 is approximately 30 psi. The second cryogenic liquid 104 is held in the second storage tank 102 as an unsaturated liquid. In an example, the second storage tank 102 can build up a pressure to approximately 500 psi, but is initially at a lower pressure. The piping system 106 between the first storage tank 101 and second storage tank 102 is connected or opened and the unsaturated second cryogenic liquid 104 flows into the first storage tank 101, as seen by the dotted line in FIG. 3.

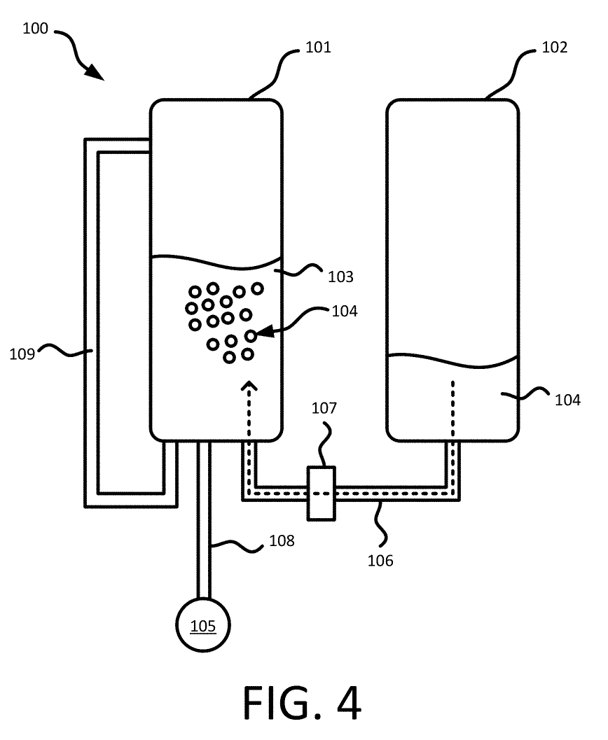

In FIG. 4, the second cryogenic liquid 104 (seen by the bubbles of the second cryogenic liquid 104 in the first storage tank 101) then subcools the first cryogenic liquid 103 in the first storage tank 101. The second cryogenic liquid 104 vaporizes in the first storage tank 101 and pressurizes at least the first storage tank 101 to a second pressure (P2) greater than P1. In one example, P2 is from approximately 110 psi to 120 psi. The volume of the ullage in the first storage tank 101 may increase. P2 may be below a threshold level of pressurization that enables effective transfer of the first cryogenic liquid 103 to the end point 105. Keeping the first storage tank 101 at this lower P2 pressure increases standby time.

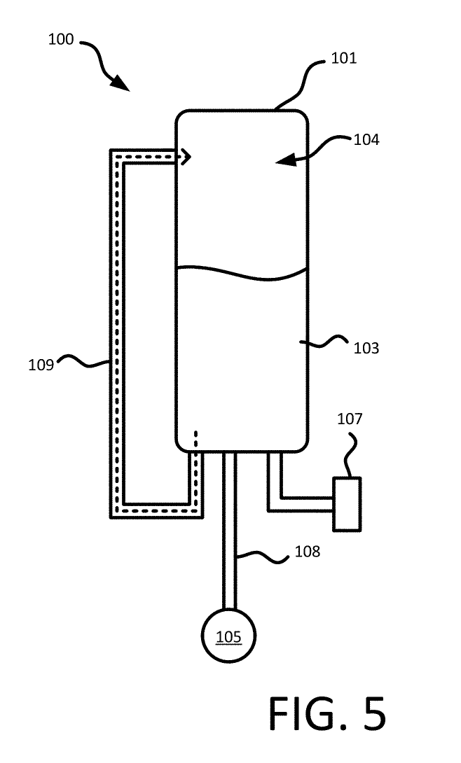

When an operator wants to transfer the first cryogenic liquid 103 in the first storage tank 101, the heat exchanger 109 is activated, as seen by the dotted line in the heat exchanger 109 in FIG. 5. The heat exchanger 109 can be activated by, for example, opening one or more valves to the heat exchanger 109 or the first storage tank 101 that enable liquid flow through the heat exchanger 109. The second storage tank 102 may be removed or remain connected to the first storage tank 101 when the heat exchanger 109 is activated. The first cryogenic liquid 103 flows into the heat exchanger 109, some or all of the first cryogenic liquid 103 in the heat exchanger 109 is vaporized, and the vapor enters the ullage space of the first storage tank 101. Thus, activation of the heat exchanger 109 causes a pressure rise in the first storage tank 101.

Use of the heat exchanger 109 when both the first cryogenic liquid 103 and second cryogenic liquid 104 are present in the first storage tank 101 causes a more rapid pressure rise than if only the first cryogenic liquid 103 is present in the first storage tank.

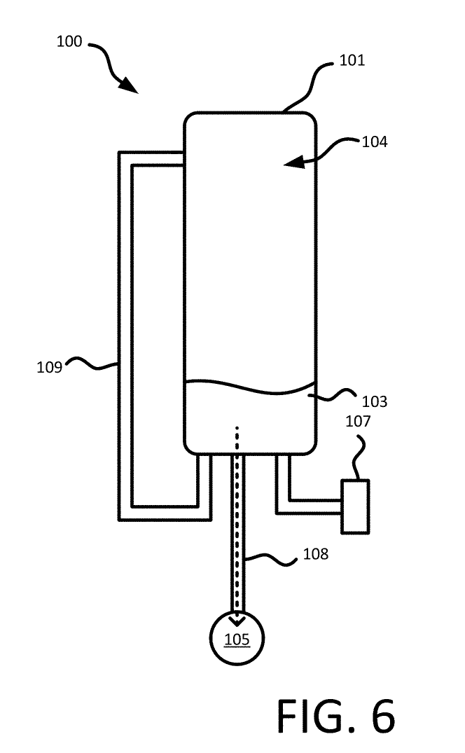

When a desired third pressure (P3) is attained using the heat exchanger, the first cryogenic liquid 103 is transferred from the first storage tank 101 through the piping network 108 to the end point 105, as seen by the dotted line in the piping network 108 in FIG. 6. P3 is greater than P2 or P1. The heat exchanger 109 may be deactivated during this fluid transfer or may remain activated to achieve or maintain a desired pressure during this fluid transfer. Before fluid transfer there may be a pressure difference between the first storage tank 101 and a receiving tank connected at the end point 105 of approximately 30 psi or more. For example, the pressure difference between the first storage tank 101 and a receiving tank connected at the end point 105 may be 50 psi. However, the pressure difference between the first storage tank 101 and a receiving tank connected at the end point 105 may be any positive pressure compared to the pressure at the receiving tank connected at the end point 105. This pressure difference and/or gravity may cause the fluid transfer.

In an embodiment, not all the first cryogenic liquid 103 is transferred from the first storage tank 101. This prevents any of the vaporized first cryogenic liquid 103 or second cryogenic liquid 104 from being transferred.

When transfer of the first cryogenic fluid 103 to the end point 105 is complete, the first storage tank 101 can be vented or filled with a cryogenic liquid, such as more of the first cryogenic liquid 103. If the first storage tank 101 is vented, the vaporized second cryogenic liquid 104 is predominantly removed during venting. If the first storage tank 101 is filled with a cryogenic liquid, then the pressure in the ullage space may be collapsed in the first storage tank 101.

The first storage tank 101 may be reconnected with a second storage tank 102 when transfer of the first cryogenic fluid 103 to the end point 105 is complete. The second cryogenic liquid 104 can again subcool, for example, the first cryogenic liquid 103, vaporize, and pressurize the first storage tank 101.

While one first storage tank 101 and one second storage tank 102 are disclosed, other numbers or configurations are possible. For example multiple second storage tanks 102 can be connected with one first storage tank 101, multiple first storage tanks 101 can be connected with one second storage tank 102, or multiple first storage tanks 101 can be connected with multiple second storage tanks 102.

In an example, the first storage tank 101 may have a volume of thousands of gallons. The second storage tank 102 may have a volume of 100 gallons. The dimensions or volumes of the first storage tank 101 and second storage tank 102 can vary.

Venting of the first cryogenic liquid 103 from the first storage tank 101 can be minimized or eliminated. If venting occurs, the vaporized second cryogenic liquid 104 is predominantly removed.

Only a limited amount of the second cryogenic liquid 104 may be needed to pressurize the first storage tank 101 and avoid venting the first cryogenic liquid 103. The heat exchanger 109 is used to supplement the pressurization effect of the second cryogenic liquid 104.

For example, less LIN is needed as a second cryogenic liquid 104 than in a previous technique. Rather than rely solely on LIN, the heat exchanger 109 can build additional pressure in the first storage tank 101. Furthermore, this LIN does not need to be on-site to build pressure. Solely relying on the vaporized nitrogen to pressurize the first storage tank 101 means that additional second cryogenic liquid 104 may be needed to maintain a desired pressure differential for transfer when the first cryogenic liquid 103 is expelled from the first storage tank 101 because the pressure in the first storage tank 101 will begin to drop. Therefore, a supply of the second cryogenic liquid 104 may be needed on-site to keep the desired pressure during transfer. However, the heat exchanger 109 can be kept operating during transfer to build pressure in the first storage tank 101 to avoid pressure drop or to provide a pressure rise during transfer. Thus, additional second cryogenic liquid 104 can be minimized or even avoided during transfer.

The pressure rise in the first storage tank 101 is more rapid than in previous techniques due to use of the heat exchanger 109 and the presence of the second cryogenic liquid 104. For example, testing has shown that use of a heat exchanger to pressurize LNG may take approximately 1-2 hours to build 100 psi of pressure in the first storage tank 101 from an initial pressure of approximately 30-40 psi. However, an addition of LIN to the LNG in the first storage tank 101 with the heat exchanger 109 can build pressure at several pounds per minute. For example, using LIN with the heat exchanger 109 can raise the pressure in excess of 6 psi/minute, which is significantly faster than use of the heat exchanger 109 alone. Furthermore, the starting pressure when the heat exchanger 109 is activated may be higher because the LIN pressurized the first storage tank 101 prior to operation of the heat exchanger 109. This starting pressure can be raised depending on the amount of LIN added to the first storage tank 101.

In another example, a pressurization test was performed on a first storage tank 101 containing LNG. Using only the heat exchanger 109, a pressure rise in the first storage tank 101 of 15 psi was obtained in 22 minutes. However, an unexpected pressure rise of 34 psi was obtained in 5 minutes using the heat exchanger 109 when the first storage tank 101 contained LNG and N₂ gas.

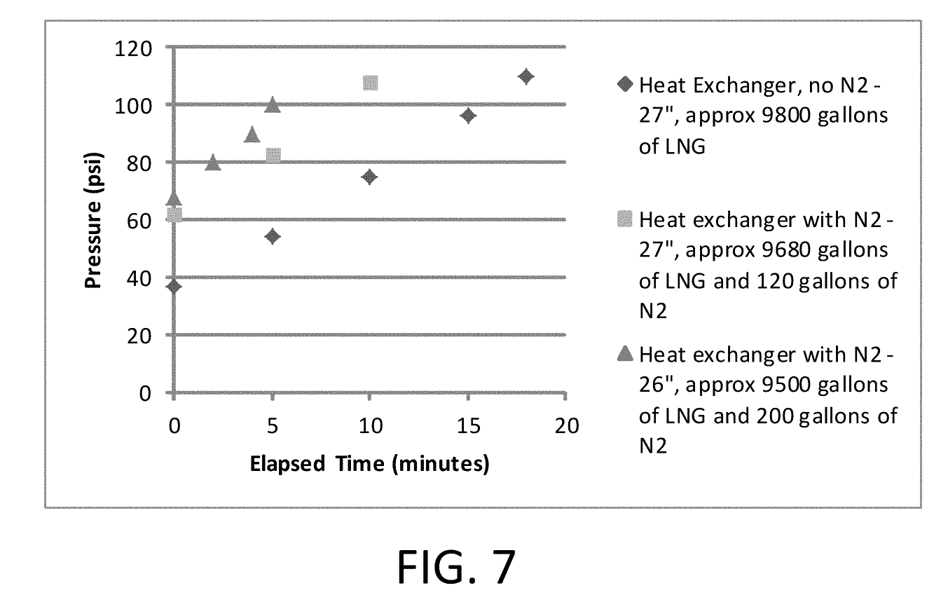

In yet another example, a pressurization test was performed on a first storage tank 101. When the first storage tank 101 contained approximately 9,800 gallons of LNG and no N₂ gas in a first experiment, the heat exchanger 109 was able to raise the pressure at a rate of approximately 4.1 psi/min. The pressure in the first storage tank 101 was raised 73 psi in 18 minutes in the first experiment. When the first storage tank 101 contained approximately 9,680 gallons of LNG and approximately 120 gallons of N₂ gas in a second experiment, the heat exchanger 109 was able to raise the pressure at a rate of approximately 4.6 psi/min. The pressure in the first storage tank 101 was raised 46 psi in 10 minutes in the second experiment. When the first storage tank 101 contained approximately 9,500 gallons of LNG and approximately 200 gallons of N₂ gas in a third experiment, the heat exchanger 109 was able to raise the pressure at a rate of approximately 6.4 psi/min. The pressure in the first storage tank 101 was raised 32 psi in 5 minutes in the third experiment. Results of this experiment are seen in FIG. 7. As seen in FIG. 7, using a combination of a heat exchanger and N₂ gas pressurized the first storage tank 101 faster and at an increased rate than using the heat exchanger alone.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a first storage tank configured to contain a first cryogenic liquid, wherein the first storage tank is insulated;
a second storage tank configured to contain a second cryogenic liquid, wherein the second storage tank is connected to the first storage tank to provide a flow of the second cryogenic liquid that subcools the first cryogenic liquid and pressurizes the first storage tank;
a heat exchanger connected to the first storage tank, wherein the heat exchanger is configured such that the first cryogenic liquid flows into the heat exchanger, vaporizes, and flows into ullage space in the first storage tank; and
a piping system connecting the first storage tank to an end point.

2. The system of claim 1, wherein the first cryogenic liquid comprises liquefied natural gas and the second cryogenic liquid comprises liquid nitrogen.

3. The system of claim 1, wherein the second storage tank is configured to be removable from the first storage tank.

4. The system of claim 1, wherein the second storage tank is connected to a bottom of the first storage tank.

5. The system of claim 1, wherein the second storage tank is connected to the first storage tank such that the flow of the second cryogenic liquid is into the first cryogenic liquid.

6. The system of claim 1, wherein the heat exchanger is configured to use at least one of gravity or head pressure to enable flow of the first cryogenic liquid through the heat exchanger.

7. The system of claim 1, wherein the piping system is connected to a bottom of the first storage tank.

8. A method comprising:
transferring a second cryogenic liquid from a second storage tank to a first storage tank that is at a first pressure, wherein the first storage tank contains a first cryogenic liquid different from the second cryogenic liquid, wherein the first cryogenic liquid has a boiling point less than or equal to −150° F. under normal atmospheric pressure, and wherein the second cryogenic liquid has a boiling point below that of the first cryogenic liquid;
subcooling the first cryogenic liquid in the first storage tank with the second cryogenic liquid;
pressurizing the first storage tank with the second cryogenic liquid to a second pressure greater than the first pressure;
pressurizing the first storage tank with a heat exchanger to a third pressure greater than the second pressure; and
transferring the first cryogenic fluid from the first storage tank when the first storage tank is at the third pressure.

9. The method of claim 8, wherein the first cryogenic liquid comprises liquefied natural gas and the second cryogenic liquid comprises liquid nitrogen.

10. The method of claim 8, further comprising venting the first storage tank after the transferring.

11. The method of claim 8, further comprising filling the first storage tank with a cryogenic liquid after the transferring.

12. The method of claim 8, further comprising using at least one of gravity or head pressure to enable the first cryogenic liquid to flow through the heat exchanger.

13. The method of claim 8, wherein the pressurizing the first storage tank with the heat exchanger continues during the transferring of the first cryogenic fluid from the first storage tank.
